(19) United States
(12) Patent Application Publication
(10) Pub. No.: US 2008/0157973 A1
(43) Pub. Date: Jul. 3, 2008

(54) System and Method for Processing Freight Using Rfid

(76) Inventors: Jeong-Hyun Park, Daejon (KR); Hye-Kyu Kim, Daejon (KR); Ki-Shik Park, Daejon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/722,175

(22) PCT Filed: Dec. 29, 2004
(86) PCT No.: PCT/KR04/03503

§ 371 Date: Jun. 19, 2007

(30) Foreign Application Priority Data
Dec. 20, 2004 (KR) 10-2004-0108830

(51) Int. Cl. G08B 13/181

(52) U.S. Cl. 340/572.2

(57) ABSTRACT

Provided are a system and method for processing freight using Radio Frequency identification (RFID). The freight processing system includes: an RFID label issuing block for issuing and attaching an RFID tag storing freight identification and destination information; an RFID linking block for generating link information between a freight and a carrier; and an RFID freight identifying block for automatically identifying the freight by reading the destination information from the RFID tag attached to the freight.

### TECHNICAL FIELD

The present invention relates to a system and a method for processing freight using Radio Frequency identification (RFID); and, more particularly, to a freight processing system using RFID that can rapidly process freight at a low cost, and a method thereof.

### BACKGROUND ART

General freight centers adopt a bar code system to process freight, e.g., packages and mails.

However, when the freight center is operated based on the bar code system, a worker should scan the bar code of a package during the linkage between a carrier and the package and identify the package should be manually for himself with his naked eyes. Also, since the bar code of a package to be delivered should be scanned one by one in delivery of the package, huge manpower and time are required and there are problems such as erroneous identification work, thereby lowering quality and competitiveness of a freight service.

### DISCLOSURE

### Technical Problem

It is, therefore, an object of the present invention to provide a freight processing system using Radio Frequency identification (RFID) that can rapidly processing freight at a low cost, and a method thereof.

It is another object of the present invention to provide a freight processing system using RFID that can rapidly processing freight such as a package at a low cost by storing identification and destination information in an RFID tag and issuing and attaching a label, and a method thereof.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

### TECHNICAL SOLUTION

In accordance with one aspect of the present invention, there is provided a freight processing system using Radio Frequency identification (RFID), including: an RFID label issuing block for issuing and attaching an RFID tag storing freight identification and destination information; an RFID linking block for generating link information between freight and a carrier; and an RFID freight identifying block for automatically identifying the freight by reading the destination information from the RFID tag attached to the freight.

Also, the freight processing system, further includes: an RFID freight delivering means for selecting the freight to be delivered by reading the freight identification information stored in the RFID tag to process a freight delivery work, and a freight information processing server for receiving, processing and managing the freight information selected to be delivered through a network from the RFID freight delivering means.

In accordance with another aspect of the present invention, there is provided a freight processing method using RFID for a freight processing system, including the steps of: a) issuing and attaching an RFID tag storing freight identification and destination information; b) automatically generating link information between freight and a carrier whenever the freight is loaded into the carrier through an RFID reader set up around the carrier; c) automatically identifying the freight by reading the destination information from the RFID tag attached to the freight; and d) selecting freight to be delivered by reading the freight identification information stored in the RFID tag to process a freight delivery work.

Also, the freight processing method further includes the step of: e) receiving, processing and managing the freight information selected to be delivered in the step d) through a network from the RFID freight delivering means in a freight information processing server.

### ADVANTAGEOUS EFFECTS

The present invention can remarkably cut down on process time of link identification and delivery work, and a cost of labor by storing identification and destination information to a Radio Frequency Identification (RFID) tag by applying an RFID technology to freight such as a package, issuing and attaching a label in a freight center.

Also, since the present invention can rapidly and precisely provide a freight delivery service by substituting manual identification by key board input of a worker, it is possible to provide a high-quality freight service at a low cost.

Also, the present invention can rapidly and automatically process the freight such as the package, which has a difficulty in automation in comparison with general freight, by using the RFID technology.

### DESCRIPTION OF DRAWINGS

The above and other objects and features of the present invention will become apparent from the following description of the preferred embodiments given in conjunction with the accompanying drawings, in which:

FIG. 1 is a diagram illustrating a freight processing system using Radio Frequency identification (RFID) and method in accordance with an embodiment of the present invention;

FIG. 2 illustrates the RFID package label issuing block of FIG. 1 in accordance with the embodiment of the present invention;

FIG. 3 illustrates the RFID package linking block of FIG. 1 in accordance with the embodiment of the present invention;

FIG. 4 illustrates the RFID package identifying block of FIG. 1 in accordance with the embodiment of the present invention;

FIG. 5 illustrates the RFID package delivering block of FIG. 1 in accordance with the embodiment of the present invention; and

FIG. 6 is a block diagram describing a freight information processing server of FIG. 1 in accordance with the embodiment of the present invention.

### BEST MODE FOR THE INVENTION

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on prior art may blur the points of the present invention, the detailed description will not be provided herein. The preferred embodiments of the present invention will be described in detail hereinafter with reference to the attached drawings.

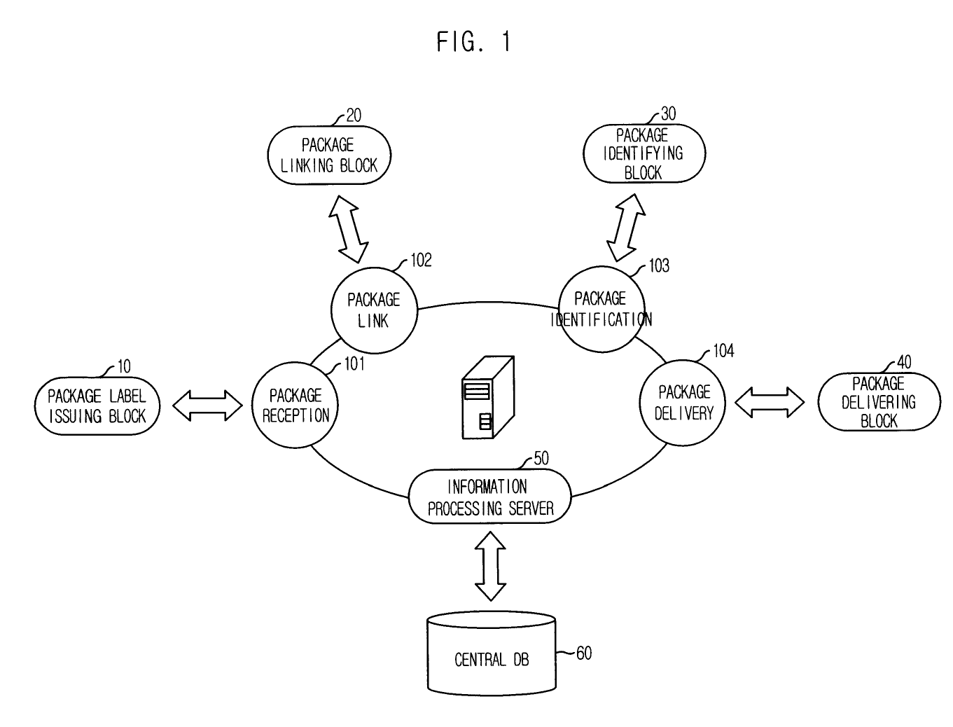

FIG. 1 is a diagram illustrating a freight processing system using Radio Frequency identification (RFID) and method in accordance with an embodiment of the present invention. FIG. 1 illustrates a package, which is a kind of freight, as an example.

As shown in the drawing, the present invention includes an RFID package label issuing block 10, an RFID package linking block 20, an RFID package identifying block 30, an RFID package delivering block 40, and a freight information processing server 50.

The RFID package label issuing block 10 attaches an RFID tag to a package, stores a postal code for designating a registration number and a destination for identifying the package into the RFID tag and issues the RFID tag as a form of a label, which can be attached to the package.

The RFID package linking block 20 automatically generates link information of a carrier and the package only by an action putting the package in the carrier and the RFID package identifying block 30 automatically performs an identification process by learning the postal code from the RFID tag. The RFID package delivering block 40 simultaneously recognizes a plurality of registration numbers to select a package to be delivered.

The present invention can rapidly and precisely process link, identification and delivery works of the package through the above structure, and the process will be described in detail hereinafter.

The RFID tag storing the registration number, which is an identification number, and the postal code, which is a destination number, are issued and attached in a form of a label in package reception (see 101), and link information is automatically generated between the carrier and the package by only the action putting the package into the carrier by setting up an RF reader in the carrier (see 102).

After a package is delivered to the freight center, a worker identifies an address or a postal code of a recipient, which is recorded in the package, with naked eyes, recognizes postal code data stored in the label-type RFID tag, which is attached to the package by setting up an RF reader to the identifying block without a key board, automatically identifies the package without inputting (see 103).

The present invention selects a package to be delivered through collectively recognizing a plurality of packages by using a PDA terminal for package delivery, in which the RF reader is embedded, differently from a conventional method for individually recognizing a registration bar code printed on the package to delivery the package, which is delivered to a post office (see 104).

The present invention can be applied to a door-to-door delivery industry and general freight industries as well as the postal freight. Since the link, identification and delivery works can be rapid and precise by attaching the RFID tag to the freight and storing an identification number and destination information such as a registration number and a postal code, a high-quality freight service can be provided.

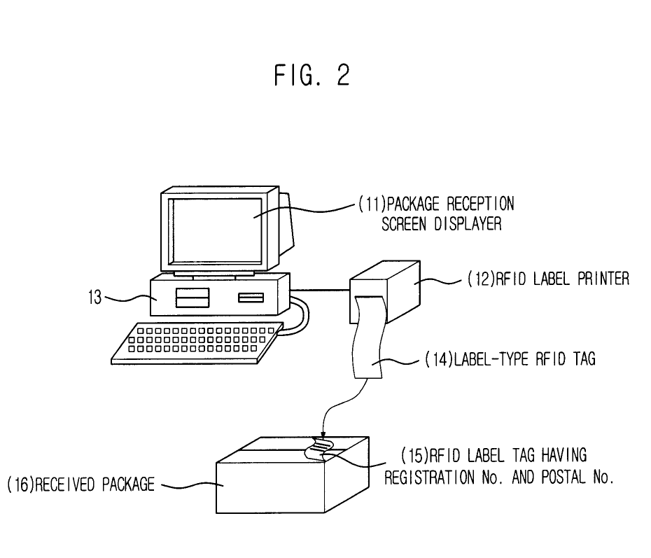

FIG. 2 illustrates the RFID package label issuing block of FIG. 1 in accordance with the embodiment of the present invention.

The RFID package label issuing block 10 stores a registration number for identifying a package in a label-type RFID tag and a postal code for identifying the package based on a delivery destination, and the RFID tag label, in which the information is successfully recorded, is attach to the package. Also, information, which can be identified by naked eyes of a man, such as the registration number is additionally printed on a surface of the RFID tag, issued and attached to the freight.

As shown in FIG. 2, the RFID package label issuing block 10 includes a package reception screen displayer 11, an RFID label printer 12, a label-type RFID tag 14, an RFID label tag 15 having the registration number and the postal number, and a Personal Computer (PC) 13 reflects package reception in a database by being connected to the freight information processing server 50 through Local Area Network (LAN), stores, issues the registration number and the postal code in the label-type RFID tag 14 and attaches the issued RFID label tag 15 to a received package 16.

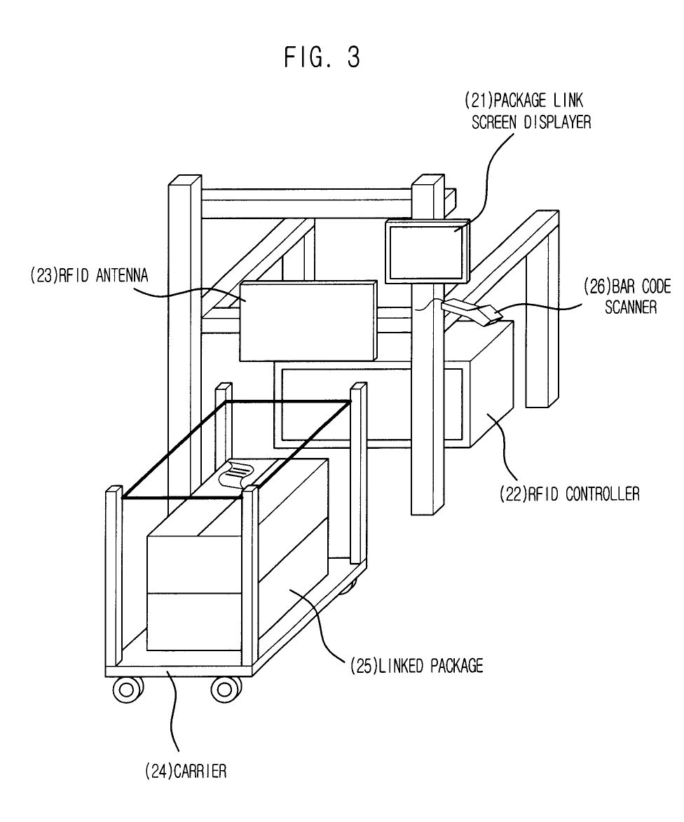

FIG. 3 illustrates the RFID package linking block of FIG. 1 in accordance with the embodiment of the present invention.

As shown in FIG. 3, the RFID package linking block 20 generates link information between a package with an RFID tag and a carrier and it includes a package link screen displayer 21, an RFID controller 22 including the RF reader and a small computer for processing information learned from the RF reader and connection with the freight information processing server 50, an RFID antenna 23 and a carrier 24 to link the package. It automatically generates link information by recognizing the RFID tag attached to the package through the RFID antenna 23 when a worker puts the package in the carrier.

Herein, the RFID package linking block 20 recognizes the RFID tag through the RFID antenna 23 by attaching the RFID tag storing a country number in the carrier 24 or recognizes the country number attached to the carrier by a bar code scanner 26, thereby selecting the carrier 24 to be linked.

In a link between freight and a carrier based on the present invention, it is a point that link information is generated only by an action putting a package with the RFID tag in the carrier by setting up the RFID reader around the carrier instead of scanning a bar code by a worker with the bar code reader one by one.

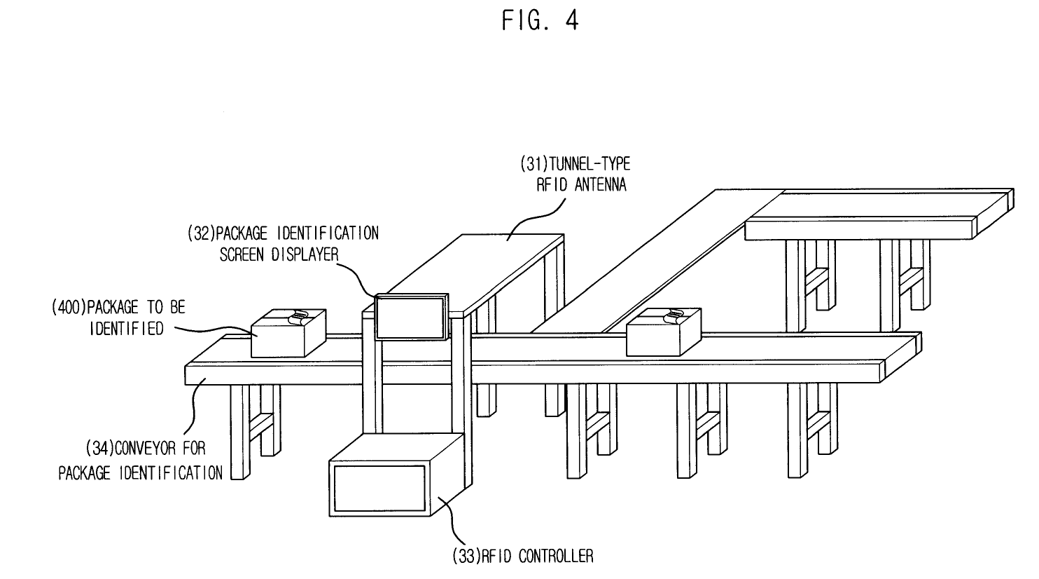

FIG. 4 illustrates the RFID package identifying block of FIG. 1 in accordance with the embodiment of the present invention.

As shown in FIG. 4, the RFID package identifying block 30 identifies a package with the RFID tag without manual data input and it includes a tunnel-type RFID antenna 31, a tunnel-type package identification screen displayer 32, an RFID controller 33, and a conveyor 34 for identifying a package. The RFID package identifying block 30 performs an identification process by reading a postal code in the RFID tag, when a package 400 to be identified goes through the tunnel-type RFID antenna 31.

Herein, the RFID controller 33 can identify the package with only the postal code read by the RFID tag without linking with the freight information processing server 50, and displays additional information on the package after searching detailed information of the package by reading a registration number in the RFID tag and linking with the freight information processing server 50 when the additional information on the package is displayed on the package identification screen displayer 32.

That is, the RFID package identifying block 30 automatically identifies the freight without a worker by reading destination information, i.e., a postal code in the RFID tag attached to the freight instead of manually identifying the freight by the key board input after checking the destination information such as an address and the postal code, which is written on the freight, by the worker.

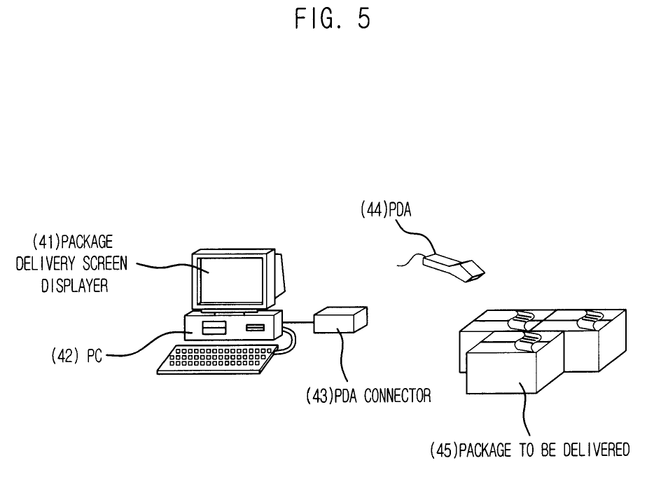

FIG. 5 illustrates the RFID package delivering block 40 of FIG. 1 in accordance with the embodiment of the present invention.

The RFID package delivering block 40 performs a delivery work by selecting a package to be delivered by collectively recognizing the package with the RFID tag and includes a package delivery screen displayer 41, a PC 42, a Personal Digital Assistant (PDA) connector 43 and a PDA 44 for delivering a package as shown in FIG. 5.

The RFID package delivering block 40 recognizes a registration number by simultaneously recognizing a plurality of RFID tags instead of recognizing a package 45 to be delivered one by one, and performs a delivery work after uploading the registration number to the freight information processing server 50 by using the PDA connector 43.

That is, the RFID package delivering block 40 processes freight to be delivered in delivery of the freight by simultaneously reading a plurality of RFID tags attached to the freight instead of scanning the freight one by one by a bar code reader based on a conventional bar code method, and processes the delivery work by selecting the freight to be delivered by reading the identification number, i.e., the registration number stored in the RFID tag.

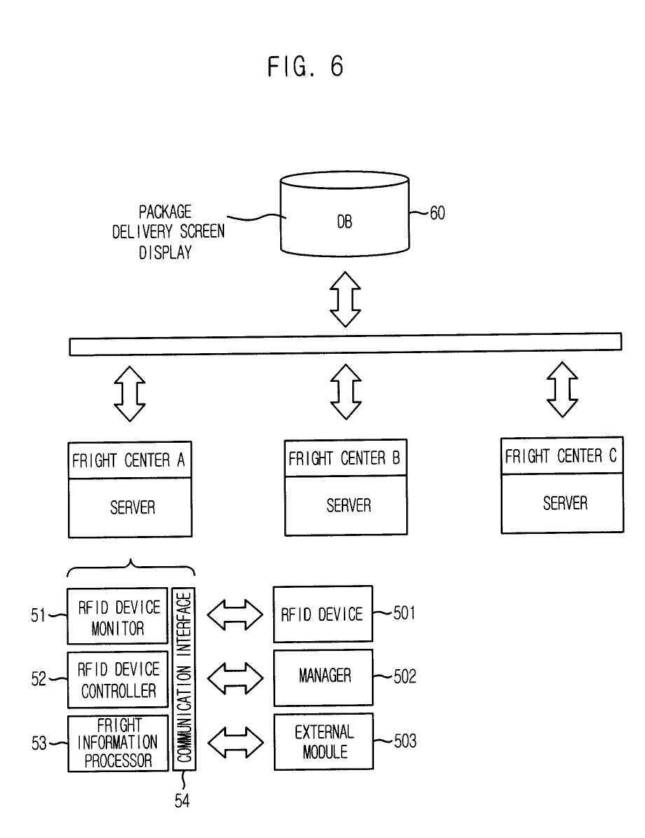

FIG. 6 is a block diagram describing a freight information processing server of FIG. 1 in accordance with the embodiment of the present invention.

The freight information processing server 50 communicates with a controller embedded in the inside of a computer or the RFID device through the LAN and reflects result data in a database by using information read from the RFID tag recognized by the RF reader. Also, it is possible to control the RFID device and monitor an operation condition of the device through the freight information processing server 50.

As shown in FIG. 6, the freight information processing server 50 is operated by being connected to a central database, which exists in each freight center and can be shared by all freight centers.

The freight information processing server 50 collects data from the RFID device, reflects the data in a database 60 and provides information required for the RFID device. The freight information processing server 50 includes an RFID device monitor 51, an RFID device controller 52, a freight information processor 53 and a communication interface 54.

Herein, the communication interface 54 has the RFID device monitor 51, the RFID device controller 52 and the freight information processor 53 communicate with an RFID device 501, a manager 502 and an external module 503 through the LAN.

As described in detail, the present invention can be embodied as a program and stored in a computer-readable recording medium, such as CD-ROM, RAM, ROM, a floppy disk, a hard disk and a magneto-optical disk. Since the process can be easily implemented by those skilled in the art, further description will not be provided herein.

While the present invention has been described with respect to certain preferred embodiments, it will be apparent to those skilled in the art that various changes and modifications may be made without departing from the scope of the invention as defined in the following claims.

What is claimed is:

1. A freight processing system using Radio Frequency identification (RFID), comprising:
an RFID label issuing means for issuing and attaching an RFID tag storing freight identification and destination information;
an RFID linking means for generating link information between freight and a carrier; and
an RFID freight identifying means for automatically identifying the freight by reading the destination information from the RFID tag attached to the freight.

2. The system as recited in claim 1, further comprising:
an RFID freight delivering means for selecting the freight to be delivered by reading the freight identification information stored in the RFID tag to process a freight delivery work.

3. The system as recited in claim 1, further comprising:
a freight information processing server for receiving, processing and managing the freight information selected to be delivered from the RFID freight delivering means through a network.

4. The system as recited in claim 3, wherein the freight information processing server exists for each freight center and stores freight processing information of each freight center in a central database so that the freight processing information of each freight center can be shared with other freight centers.

5. The system as recited in claim 4, wherein the RFID label issuing means further performs a function printing information that can be checked by naked eyes on a surface of the RFID tag.

6. The system as recited in claim 4, wherein the RFID linking means sets up the RFID reader around the carrier to generate link information only by an action putting the freight into the carrier having the RFID tag.

7. The system as recited in claim 4, wherein the RFID freight delivering means simultaneously reads and processes many freight identification information stored in the RFID tag.

8. A freight processing method using Radio Frequency identification (RFID) for a freight processing system, comprising the steps of:
a) issuing and attaching an RFID tag storing freight identification and destination information;
b) automatically generating link information between freight and a carrier whenever the freight is loaded into the carrier through an RFID reader set up around the carrier;
c) automatically identifying the freight by reading the destination information from the RFID tag attached to the freight; and
d) selecting freight to be delivered by reading the freight identification information stored in the RFID tag to process a freight delivery work.

9. The method as recited in claim 8, further comprising the step of:
e) receiving, processing and managing the freight information selected to be delivered in the step d) through a network from the RFID freight delivering means in a freight information processing server.
